(19) United States
(12) Patent Application Publication
(10) Pub. No.: US 2010/0208796 A1
(43) Pub. Date: Aug. 19, 2010

(54) METHODS AND APPARATUS FOR INCORPORATING VIDEO USABILITY INFORMATION (VUI) WITHIN A MULTI-VIEW VIDEO (MVC) CODING SYSTEM

(75) Inventors: Jiancong Luo, Plainsboro, NJ (US); Peng Yin, West Windsor, NJ (US)

Correspondence Address: Robert D. Shedd, Patent Operations;THOMSON Licensing LLC, P.O. Box 5312, Princeton, NJ, 08543-5312, US

(73) Assignee: Thomson Licensing LLC, Princeton, NJ (US)

(21) Appl. No.: 12/734,023

(22) PCT Filed: Sep. 16, 2008
(86) PCT No.: PCT/US08/10775

§ 371 Date: Apr. 5, 2010

Related U.S. Application Data
(60) Provisional application No. 60/977,709, filed on Oct. 5, 2007.

(51) Int. Cl. H04N 7/26

(52) U.S. Cl. 375/240.02; 375/E07.126

(57) ABSTRACT

There are provided methods and apparatus for incorporating video usability information (VUI) within multi-view video coding (MVC). An apparatus includes an encoder for encoding multi-view video content by specifying video usability information for at least one selected from: individual views, individual temporal levels in a view, and individual operating points. Further, an apparatus includes a decoder for decoding multi-view video content by specifying video usability information for at least one selected from: individual views, individual temporal levels in a view, and individual operating points.

### CROSS-REFERENCE TO RELATED APPLICATIONS

This application claims the benefit of U.S. Provisional Application Ser. No. 60/977,709, filed Oct. 5, 2007, which is incorporated by reference herein in its entirety. Further, this application is related to the non-provisional application, Attorney Docket No. PU070239, entitled “METHODS AND APPARATUS FOR INCORPORATING VIDEO USABILITY INFORMATION (VUI) WITHIN A MULTI-VIEW VIDEO (MVC) CODING SYSTEM”, which also claims the benefit of U.S. Provisional Application Ser. No. 60/977,709, filed Oct. 5, 2007, and which is commonly assigned, incorporated by reference herein, and concurrently filed herewith.

### TECHNICAL FIELD

The present principles relate generally to video encoding and decoding and, more particularly, to methods and apparatus for incorporating video usability information (VUI) within multi-view video coding (MVC).

### BACKGROUND

The International Organization for Standardization/International Electrotechnical Commission (ISO/IEC) Moving Picture Experts Group-4 (MPEG-4) Part 10 Advanced Video Coding (AVC) standard/International Telecommunication Union, Telecommunication Sector (ITU-T) H.264 recommendation (hereinafter the “MPEG-4 AVC standard”) specifies syntax and semantics of video usability information (VUI) parameters of sequence parameter sets. Video usability information includes information of aspect ratio, over-scanning, video signal type, chroma location, timing, network abstraction layer (NAL) hypothetical reference decoder (HRD) parameters, video coding layer (VCL) hypothetical reference decoder parameters, bitstream restriction, and so forth. Video usability information provides extra information for a corresponding bitstream to permit a wider application for a user. For example, in bitstream restriction information, video usability information specifies: (1) if the motion is over a picture boundary; (2) the maximal bytes per picture; (3) the maximal bits per macroblock; (4) the maximal motion vector length (horizontal and vertical); (5) the number of reordering frames; and (6) the maximal decoded frame buffer size. When the decoder sees the information, instead of using the “level” information to set the decoding requirement, which in general is higher than what the bitstream actually requires, the decoder can customize its decoding operation based on the tighter limit.

Multi-view video coding (MVC) is an extension to the MPEG-4 AVC Standard. In multi-view video coding, video images for multiple views can be encoded by exploiting the correlation between views. Among all views, one view is the base view, which is MPEG-4 AVC Standard compatible and cannot be predicted from the other views. The other views are referred to as non-base views. Non-base views can be predictively encoded from the base view and other non-base views. Each view can be temporally sub-sampled. A temporal subset of a view can be identified by a temporal_id syntax element. A temporal level of a view is one representation of the video signal. There can be different combinations of views and temporal levels in a multi-view video coded bitstream. Each combination is called an operation point. Sub-bitstreams, corresponding to the operation points, may be extracted from the bitstream.

### SUMMARY

These and other drawbacks and disadvantages of the prior art are addressed by the present principles, which are directed to methods and apparatus for incorporating video usability information (VUI) within multi-view video coding (MVC).

According to an aspect of the present principles, there is provided an apparatus. The apparatus includes an encoder for encoding multi-view video content by specifying video usability information for at least one of individual views, individual temporal levels in a view, and individual operating points.

According to another aspect of the present principles, there is provided a method. The method includes encoding multi-view video content by specifying video usability information for at least one of individual views, individual temporal levels in a view, and individual operating points.

According to yet another aspect of the present principles, there is provided an apparatus. The apparatus includes a decoder for decoding multi-view video content by specifying video usability information for at least one of individual views, individual temporal levels in a view, and individual operating points.

According to still another aspect of the present principles, there is provided a method. The method includes decoding multi-view video content by specifying video usability information for at least one of individual views, individual temporal levels in a view, and individual operating points.

These and other aspects, features and advantages of the present principles will become apparent from the following detailed description of exemplary embodiments, which is to be read in connection with the accompanying drawings.

### BRIEF DESCRIPTION OF THE DRAWINGS

The present principles may be better understood in accordance with the following exemplary figures, in which:

FIG. 1 is a block diagram for an exemplary Multi-view Video Coding (MVC) encoder to which the present principles may be applied, in accordance with an embodiment of the present principles;

FIG. 2 is a block diagram for an exemplary Multi-view Video Coding (MVC) decoder to which the present principles may be applied, in accordance with an embodiment of the present principles;

FIG. 3 is a flow diagram for an exemplary method for encoding bitstream restriction parameters for each view, using a mvc_vui_parameters_extension( ) syntax element, in accordance with an embodiment of the present principles;

FIG. 4 is a flow diagram for an exemplary method for decoding bitstream restriction parameters for each view, using a mvc_vui_parameters_extension( ) syntax element, in accordance with an embodiment of the present principles;

FIG. 5 is a flow diagram for an exemplary method for encoding bitstream restriction parameters for each temporal level in each view, using a mvc_vui_parameters_extension( ) syntax element, in accordance with an embodiment of the present principles;

FIG. 6 is a flow diagram for an exemplary method for decoding bitstream restriction parameters for each temporal level in each view, using a mvc_vui_parameters_extension( ) syntax element, in accordance with an embodiment of the present principles;

FIG. 7 is a flow diagram for an exemplary method for encoding bitstream restriction parameters for each operation point, using a view_scalability_parameters_extension( ) syntax element, in accordance with an embodiment of the present principles; and

FIG. 8 is a flow diagram for an exemplary method for decoding bitstream restriction parameters for each operation point, using a view_scalability_parameters_extension( ) syntax element, in accordance with an embodiment of the present principles.

### DETAILED DESCRIPTION

The present principles are directed to methods and apparatus for incorporating video usability information (VUI) within multi-view video coding (MVC).

The present description illustrates the present principles. It will thus be appreciated that those skilled in the art will be able to devise various arrangements that, although not explicitly described or shown herein, embody the present principles and are included within its spirit and scope.

All examples and conditional language recited herein are intended for pedagogical purposes to aid the reader in understanding the present principles and the concepts contributed by the inventor(s) to furthering the art, and are to be construed as being without limitation to such specifically recited examples and conditions.

Moreover, all statements herein reciting principles, aspects, and embodiments of the present principles, as well as specific examples thereof, are intended to encompass both structural and functional equivalents thereof. Additionally; it is intended that such equivalents include both currently known equivalents as well as equivalents developed in the future, i.e., any elements developed that perform the same function, regardless of structure.

Thus, for example, it will be appreciated by those skilled in the art that the block diagrams presented herein represent conceptual views of illustrative circuitry embodying the present principles. Similarly, it will be appreciated that any flow charts, flow diagrams, state transition diagrams, pseudocode, and the like represent various processes which may be substantially represented in computer readable media and so executed by a computer or processor, whether or not such computer or processor is explicitly shown.

The functions of the various elements shown in the figures may be provided through the use of dedicated hardware as well as hardware capable of executing software in association with appropriate software. When provided by a processor, the functions may be provided by a single dedicated processor, by a single shared processor, or by a plurality of individual processors, some of which may be shared. Moreover, explicit use of the term “processor” or “controller” should not be construed to refer exclusively to hardware capable of executing software, and may implicitly include, without limitation, digital signal processor (“DSP”) hardware, read-only memory (“ROM”) for storing software, random access memory (“RAM”), and non-volatile storage.

Other hardware, conventional and/or custom, may also be included. Similarly, any switches shown in the figures are conceptual only. Their function may be carried out through the operation of program logic, through dedicated logic, through the interaction of program control and dedicated logic, or even manually, the particular technique being selectable by the implementer as more specifically understood from the context.

In the claims hereof, any element expressed as a means for performing a specified function is intended to encompass any way of performing that function including, for example, a) a combination of circuit elements that performs that function or b) software in any form, including, therefore, firmware, microcode or the like, combined with appropriate circuitry for executing that software to perform the function. The present principles as defined by such claims reside in the fact that the functionalities provided by the various recited means are combined and brought together in the manner which the claims call for. It is thus regarded that any means that can provide those functionalities are equivalent to those shown herein.

Reference in the specification to “one embodiment” or “an embodiment” of the present principles means that a particular feature, structure, characteristic, and so forth described in connection with the embodiment is included in at least one embodiment of the present principles. Thus, the appearances of the phrase “in one embodiment” or “in an embodiment” appearing in various places throughout the specification are not necessarily all referring to the same embodiment.

It is to be appreciated that the use of the terms “and/or” and “at least one of”, for example, in the cases of “A and/or B” and “at least one of A and B”, is intended to encompass the selection of the first listed option (A) only, or the selection of the second listed option (B) only, or the selection of both options (A and B). As a further example, in the cases of “A, B, and/or C” and “at least one of A, B, and C”, such phrasing is intended to encompass the selection of the first listed option (A) only, or the selection of the second listed option (B) only, or the selection of the third listed option (C) only, or the selection of the first and the second listed options (A and B) only, or the selection of the first and third listed options (A and C) only, or the selection of the second and third listed options (B and C) only, or the selection of all three options (A and B and C). This may be extended, as readily apparent by one of ordinary skill in this and related arts, for as many items listed.

Multi-view video coding (MVC) is the compression framework for the encoding of multi-view sequences. A Multi-view Video Coding (MVC) sequence is a set of two or more video sequences that capture the same scene from a different view point.

As interchangeably used herein, “cross-view” and “inter-view” both refer to pictures that belong to a view other than a current view.

Moreover, as used herein, “high level syntax” refers to syntax present in the bitstream that resides hierarchically above the macroblock layer. For example, high level syntax, as used herein, may refer to, but is not limited to, syntax at the slice header level, Supplemental Enhancement Information (SEI) level, Picture Parameter Set (PPS) level, Sequence Parameter Set (SPS) level and Network Abstraction Layer (NAL) unit header level.

Also, it is to be appreciated that while one or more embodiments of the present principles are described herein for illustrative purposes with respect to the multi-view video coding extension of the MPEG-4 AVC standard, the present principles are not limited to solely this extension and/or this standard and, thus, may be utilized with respect to other video coding standards, recommendations, and extensions thereof, while maintaining the spirit of the present principles.

Additionally, it is to be appreciated that while one or more embodiments of the present principles are described herein for illustrative purposes with respect to bitstream restriction information, the present principles are not limited to solely using bitstream restriction information as a type of video usability information and, thus, other types of video usability information that may be extended for use with respect to multi-video video coding may also be used in accordance with the present principles, while maintaining the spirit of the present principles.

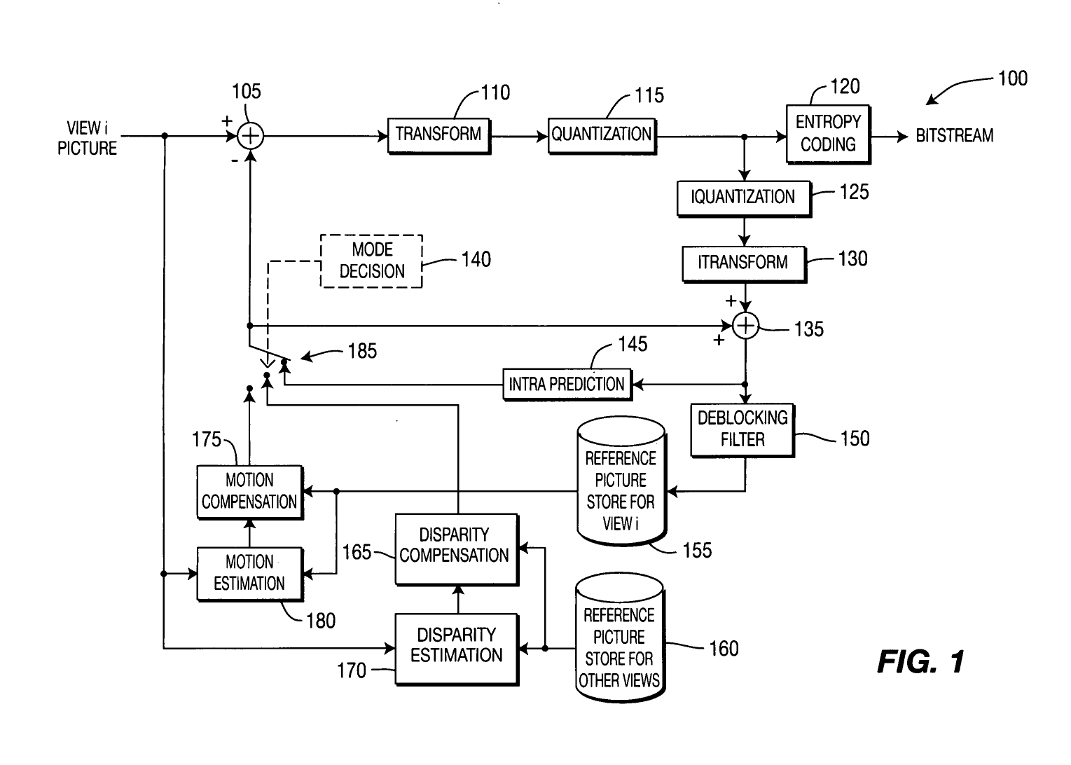

Turning to FIG. 1, an exemplary Multi-view Video Coding (MVC) encoder is indicated generally by the reference numeral 100. The encoder 100 includes a combiner 105 having an output connected in signal communication with an input of a transformer 110. An output of the transformer 110 is connected in signal communication with an input of quantizer 115. An output of the quantizer 115 is connected in signal communication with an input of an entropy coder 120 and an input of an inverse quantizer 125. An output of the inverse quantizer 125 is connected in signal communication with an input of an inverse transformer 130. An output of the inverse transformer 130 is connected in signal communication with a first non-inverting input of a combiner 135. An output of the combiner 135 is connected in signal communication with an input of an intra predictor 145 and an input of a deblocking filter 150. An output of the deblocking filter 150 is connected in signal communication with an input of a reference picture store 155 (for view i). An output of the reference picture store 155 is connected in signal communication with a first input of a motion compensator 175 and a first input of a motion estimator 180. An output of the motion estimator 180 is connected in signal communication with a second input of the motion compensator 175

An output of a reference picture store 160 (for other views) is connected in signal communication with a first input of a disparity/illumination estimator 170 and a first input of a disparity/illumination compensator 165. An output of the disparity/illumination estimator 170 is connected in signal communication with a second input of the disparity/illumination compensator 165.

An output of the entropy decoder 120 is available as an output of the encoder 100. A non-inverting input of the combiner 105 is available as an input of the encoder 100, and is connected in signal communication with a second input of the disparity/illumination estimator 170, and a second input of the motion estimator 180. An output of a switch 185 is connected in signal communication with a second non-inverting input of the combiner 135 and with an inverting input of the combiner 105. The switch 185 includes a first input connected in signal communication with an output of the motion compensator 175, a second input connected in signal communication with an output of the disparity/illumination compensator 165, and a third input connected in signal communication with an output of the intra predictor 145.

A mode decision module 140 has an output connected to the switch 185 for controlling which input is selected by the switch 185.

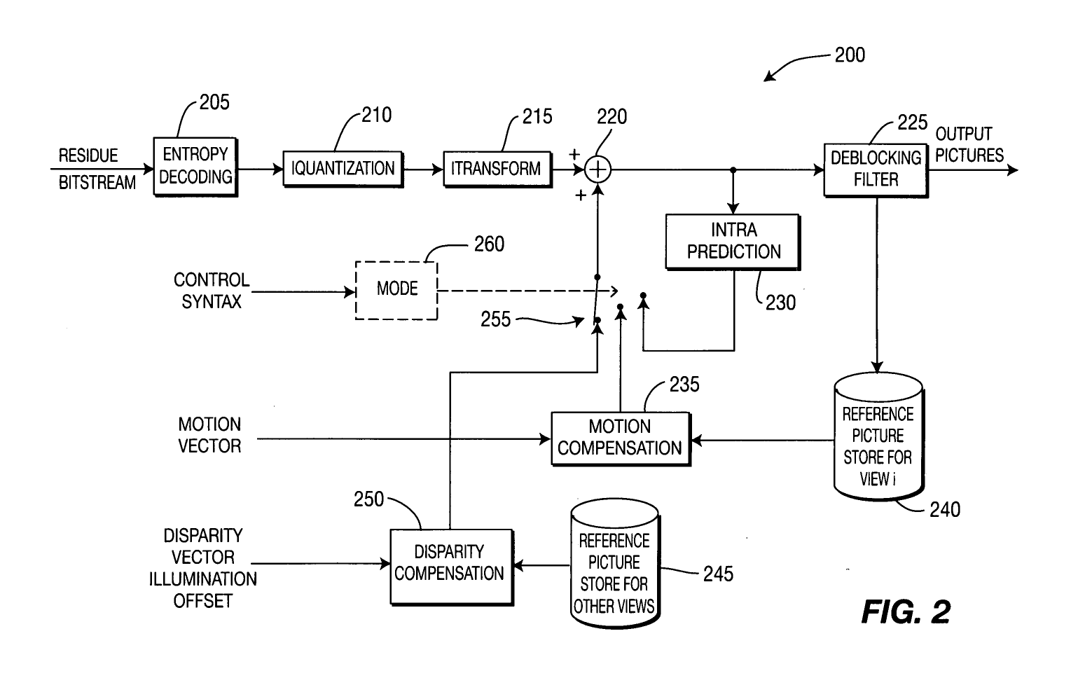

Turning to FIG. 2, an exemplary Multi-view Video Coding (MVC) decoder is indicated generally by the reference numeral 200. The decoder 200 includes an entropy decoder 205 having an output connected in signal communication with an input of an inverse quantizer 210. An output of the inverse quantizer is connected in signal communication with an input of an inverse transformer 215. An output of the inverse transformer 215 is connected in signal communication with a first non-inverting input of a combiner 220. An output of the combiner 220 is connected in signal communication with an input of a deblocking filter 225 and an input of an intra predictor 230. An output of the deblocking filter 225 is connected in signal communication with an input of a reference picture store 240 (for view i). An output of the reference picture store 240 is connected in signal communication with a first input of a motion compensator 235.

An output of a reference picture store 245 (for other views) is connected in signal communication with a first input of a disparity/illumination compensator 250.

An input of the entropy decoder 205 is available as an input to the decoder 200, for receiving a residue bitstream. Moreover, an input of a mode module 260 is also available as an input to the decoder 200, for receiving control syntax to control which input is selected by the switch 255. Further, a second input of the motion compensator 235 is available as an input of the decoder 200, for receiving motion vectors. Also, a second input of the disparity/illumination compensator 250 is available as an input to the decoder 200, for receiving disparity vectors and illumination compensation syntax.

An output of a switch 255 is connected in signal communication with a second non-inverting input of the combiner 220. A first input of the switch 255 is connected in signal communication with an output of the disparity/illumination compensator 250. A second input of the switch 255 is connected in signal communication with an output of the motion compensator 235. A third input of the switch 255 is connected in signal communication with an output of the intra predictor 230. An output of the mode module 260 is connected in signal communication with the switch 255 for controlling which input is selected by the switch 255. An output of the deblocking filter 225 is available as an output of the decoder.

In the MPEG-4 AVC Standard, syntax and semantic parameters of the sequence parameter sets are specified for video usability information (VUI). This represents additional information that may be inserted into a bitstream to enhance the usability of the video for a wide variety of purposes. Video usability information includes information of aspect ratio, over-scanning, video signal type, chroma location, timing, network abstraction layer (NAL) hypothetical reference decoder (HRD) parameters, video coding layer (VCL) hypothetical reference decoder parameters, bitstream restriction, and so forth.

In accordance with one or more embodiments of the present principles, we use this existing video usability information field for new and different purposes than in the prior art and, further, extend its use to multi-view video coding (MVC). In our multi-view video coding scheme, the video usability information is extended so that it may be different between, for example, different views, different temporal levels in a view, or different operation points. Thus, in accordance with an embodiment, we specify video usability information according to one or more of, but not limited to, the following: specifying the video usability information for individual views; specifying the video usability information for individual temporal levels in a view; and specifying the video usability information for individual operation points separately.

In the MPEG-4 AVC Standard, a set that includes Video Usability Information (VUI) can be transmitted in a sequence parameter set (SPS). In accordance with an embodiment, we extend the concept of video usability information for use within a multi-view video coding (MVC) context. Advantageously, this allows different video usability information to be specified for different views, different temporal levels in a view, or different operation points in multi-view video coding. In an embodiment, we provide a novel approach in considering, modifying, and using bitstream restriction information in video usability information for multi-view video coding.

The bitstream restriction information in the MPEG-4 AVC Standard is specified in the vui_parameters( ) syntax element which is a part of the sequence_parameter_set( ) TABLE 1 illustrates the MPEG-4 AVC Standard syntax of vui_parameters( )

TABLE 1

| vui_parameters( ) { | | C | Descriptor |
|---|---|---|---|
| | aspect_ratio_info_present_flag | 0 | u(1) |
| | ... | | |
| | bitstream_restriction_flag | 0 | u(1) |
| | if( bitstream_restriction_flag ) { | | |

| | | |
|---|---|---|
| motion_vectors_over_pic_boundaries_flag | 0 | u(1) |
| max_bytes_per_pic_denom | 0 | ue(v) |
| max_bits_per_mb_denom | 0 | ue(v) |
| log2_max_mv_length_horizontal | 0 | ue(v) |
| log2_max_mv_length_vertical | 0 | ue(v) |
| num_reorder_frames | 0 | ue(v) |
| max_dec_frame_buffering | 0 | ue(v) |

}

}

The semantics of the syntax elements of bitstream restriction information are as follows:
bitstream_restriction_flag equal to 1 specifies that the following coded video sequence bitstream restriction parameters are present. bitstream_restriction_flag equal to 0 specifies that the following coded video sequence bitstream restriction parameters are not present.
motion_vectors_over_pic_boundaries_flag equal to 0 indicates that no sample outside the picture boundaries and no sample at a fractional sample position whose value is derived using one or more samples outside the picture boundaries are used to inter predict any sample. motion_vectors_over_pic_boundaries_flag equal to 1 indicates that one or more samples outside picture boundaries may be used in inter prediction.
When the motion_vectors_over_pic_boundaries_flag syntax element is not present, motion_vectors_over_pic_boundaries_flag value shall be inferred to be equal to 1.
max_bytes_per_pic_denom indicates a number of bytes not exceeded by the sum of the sizes of the virtual coding layer (VCL) network abstraction layer (NAL) units associated with any coded picture in the coded video sequence.
The number of bytes that represent a picture in the network abstraction layer unit stream is specified for this purpose as the total number of bytes of virtual coding layer network abstraction layer unit data (i.e., the total of the NumByteslnNALunit variables for the virtual coding layer network abstraction layer units) for the picture. The value of max_bytes_per_pic_denom shall be in the range of 0 to 16, inclusive.

Depending on max_bytes_per_pic_denom the following applies:
If max_bytes_per_pic_denom is equal to 0, then no limits are indicated.
Otherwise (max_bytes_per_pic_denom is not equal to 0), no coded picture shall be represented in the coded video sequence by more than the following number of bytes:

(PicSizeInMbs*RawMbBits)÷(8*max_bytes_per_pic_denom)

When the max_bytes_per_pic_denom syntax element is not present, the value of max_bytes_per_pic_denom shall be inferred to be equal to 2. The variable PicSizeInMbs is the number of macroblocks in the picture. The variable RawMbBits is derived as in sub-clause 7.4.2.1 of MPEG-4 AVC Standard.
max_bits_per_mb_denom indicates the maximum number of coded bits of macroblocklayer( ) data for any macroblock in any picture of the coded video sequence. The value of max_bits_per_mb_denom shall be in the range of 0 to 16, inclusive.

Depending on max_bits_per_mb_denom the following applies:
—If max_bits_per_mb_denom is equal to 0, then no limit is specified.
Otherwise (max_bits_per_mb_denom is not equal to 0), no coded macroblock_layer( ) shall be represented in the bitstream by more than the following number of bits.

(128+RawMbBits)÷max_bits_per_mb_denom

Depending on entropy_coding_mode_flag, the bits of macroblock_layer( ) data are counted as follows:
If entropy_coding_mode_flag is equal to 0, then the number of bits of macroblock_layer( ) data is given by the number of bits in the macroblock_layer( ) syntax structure for a macroblock.
Otherwise (entropy_coding_mode_flag is equal to 1), the number of bits of macroblock_layer( ) data for a macroblock is given by the number of times read_bits (1) is called in sub-clauses 9.3.3.2.2 and 9.3.3.2.3 of he MPEG-4 AVC Standard when parsing the macroblock_layer( ) associated with the macroblock.
When the max_bits_per_mb_denom is not present, the value of max_bits_per_mb_denom shall be inferred to be equal to 1.
log 2_max_mv_length_horizontal and log 2_max_mv_length_vertical indicate the maximum absolute value of a decoded horizontal and vertical motion vector component, respectively, in ¼ luma sample units, for all pictures in the coded video sequence. A value of n asserts that no value of a motion vector component shall exceed the range from −2ⁿ to 2ⁿ−1, inclusive, in units of ¼ luma sample displacement. The value of log 2_max_mv_length_horizontal shall be in the range of 0 to 16, inclusive. The value of log 2_max_mv_length_vertical shall be in the range of 0 to 16, inclusive. When log 2_max_mv_length_horizontal is not present, the values of log 2_max_mv_length_horizontal and log 2_max_mv_length_vertical shall be inferred to be equal to 16. It is to be noted that the maximum absolute value of a decoded vertical or horizontal motion vector component is also constrained by profile and level limits as specified in Annex A of the MPEG-4 AVC Standard.
num_reorder_frames indicates the maximum number of frames, complementary field pairs, or non-paired fields that respectively precede any frame, complementary field pair, or non-paired field in the coded video sequence in decoding order and follow it in output order. The value of num_reorder_frames shall be in the range of 0 to max_dec_frame_buffering, inclusive. When the num_reorder_frames syntax element is not present, the value of num_reorder_frames shall be inferred as follows:
   —If profile_idc is equal to 44, 100, 110, 122, or 244 and constraint_set3_flag is equal to 1, then the value of num_reorder_frames shall be inferred to be equal to 0.
   Otherwise (profile_idc is not equal to 44, 100, 110, 122, or 244 or constraint_set3_flag is equal to 0), the value of num_reorder_frames shall be inferred to be equal to max_dec_frame_bufferingMaxDpbSize.
max_dec_frame_buffering specifies the required size of the hypothetical reference decoder decoded picture buffer (DPB) in units of frame buffers. The coded video sequence shall not require a decoded picture buffer with size of more than Max(1, max_dec_frame_buffering) frame buffers to enable the output of decoded pictures at the output times specified by dpb_output_delay of the picture timing Supplemental Enhancement Information (SEI) messages. The value of max_dec_frame_buffering shall be in the range of num_ref_frames to MaxDpbSize (as specified in subclause A.3.1 or A.3.2 of the MPEG-4 AVC Standard), inclusive. When the max_dec_frame_buffering syntax element is not present, the value of max_dec_frame_buffering shall be inferred as follows:
   —If profile_idc is equal to 44 or 244 and constraint_set3_flag is equal to 1, then the value of max_dec_frame_buffering shall be inferred to be equal to 0.
   Otherwise (profile_idc is not equal to 44 or 244 or constraint_set3_flag is equal to 0), the value of max_dec_frame_buffering shall be inferred to be equal to MaxDpbSize.

In multi-view video coding, the bitstream restriction parameters customize the decoding operation of a sub-stream based on tighter limits. Therefore, the bitstream restriction parameters shall be allowed to be specified for each extractable sub-stream of a multi-view video coded bitstream. In accordance with an embodiment, we propose to specify bitstream restriction information for each view, for each temporal level in a view, and/or for each operation point.

### Specifying Bitstream Restriction Parameters for Each View.

Bitstream restriction parameters can be specified for each view. We propose the syntax of mvc_vui_parameters_extension, which is a part of subset_sequence_parameter_set. TABLE 2 illustrates the syntax of mvc_vui_parameters_extension.
mvc_vui_parameters_extension( ) loops over all the views that are associated to this subset_sequence_parameter_set. The view_id of each view and the bitstream restriction parameters of each view are specified inside the loop.

TABLE 2

| mvc_vui_parameters_extension( ) { | | C | Descriptor |
|---|---|---|---|
| | num_views_minus1 | 0 | ue(v) |
| | for( i = 0; i <= num_views_minus1; i++ ) { | | |

| | | |
|---|---|---|
| view_id[ i ] | 0 | u(3) |
| bitstream_restriction_flag[ i ] | 0 | u(1) |
| if( bitstream_restriction_flag[ i ] ) { | | |

| | | |
|---|---|---|
| motion_vectors_over_pic_boundaries_flag[ i ] | 0 | u(1) |
| max_bytes_per_pic_denom[ i ] | 0 | ue(v) |
| max_bits_per_mb_denom[ i ] | 0 | ue(v) |
| log2_max_mv_length_horizontal[ i ] | 0 | ue(v) |
| log2_max_mv_length_vertical[ i ] | 0 | ue(v) |
| num_reorder_frames[ i ] | 0 | ue(v) |
| max_dec_frame_buffering[ i ] | 0 | ue(v) |

}

}

}

The semantics of the bitstream restriction syntax elements are as follows:
bitstream_restriction_flag [i] specifies the value of bitstream restriction_flag of the view having view_id[i] equal to view_id. motion_vectors_over_pic_boundaries_flag [i] specifies the value of motion_vectors_over_pic_boundaries_flag of the view having view_id[i] equal to view_id. When the motion_vectors_over_pic_boundaries_flag[i] syntax element is not present, the value of motion_vectors_over_pic_boundaries_flag for the view having view_id[i] equal to view_id shall be inferred to be equal to 1.
max_bytes_per_pic_denom [i] specifies the max_bytes_per_pic_denom value of the view having view_id[i] equal to view_id. When the max_bytes_per_pic_denom[i] syntax element is not present, the value of max_bytes_per_pic_denom of the view having view_id[i] equal to view_id shall be inferred to be equal to 2.
max_bits_per_mb_denom [i] specifies the max_bits_per_mb_denom value of the view having view_id[i] equal to view_id. When the max_bits_per_mb_denom[i] is not present, the value of max_bits_per_mb_denom of the view having view_id[i] equal to view_id shall be inferred to be equal to 1.
log 2_max_mv_length_horizontal [i] and log 2_max_mv_length_vertical [i] respectively specify the values of log 2_max_mv_length_horizontal and log 2_max_mv_length_vertical of the view having view_id[i] equal to view_id. When log 2_max_mv_length_horizontal[i] is not present, the values of log 2_max_mv_length_horizontal and log 2_max_mv_length_vertical of the view having view_id[i] equal to view_id shall be inferred to be equal to 16.
num_reorder_frames [i] specifies the value of num_reorder_frames of the view having view_id[i] equal to view_id. The value of num_reorder_frames[i] shall be in the range of 0 to max_dec_frame_buffering, inclusive. When the num_reorder_frames[i] syntax element is not present, the value of num_reorder_frames of the view having view_id[i] equal to view_id shall be inferred to be equal to max_dec_frame_buffering.
max_dec_frame_buffering [i] specifies the value of max_dec_frame_buffering of the view having view_id[i] equal to view_id. The value of max_dec_frame_buffering[i] shall be in the range of num_ref_frames[i] to MaxDpbSize (as specified in sub-clause A.3.1 or A.3.2 in the MPEG-4 AVC Standard), inclusive. When the max_dec_frame_buffering[i] syntax element is not present, the value of max_dec_frame_buffering of the view having view_id[i] equal to view_id shall be inferred to be equal to MaxDpbSize.

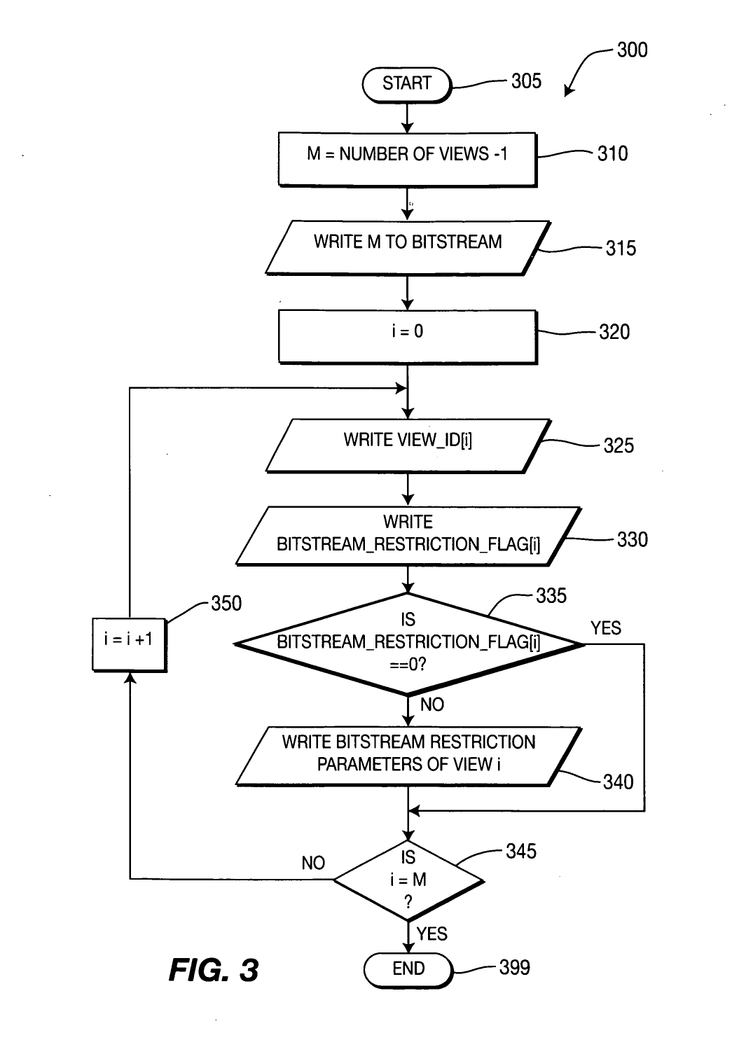

Turning to FIG. 3, an exemplary method for encoding bitstream restriction parameters for each view, using a mvc_vui_parameters_extension( ) syntax element, is indicated generally by the reference numeral 300.

The method 300 includes a start block 305 that passes control to a function block 310. The function block 310 sets a variable M equal to a number of views minus one, and passes control to a function block 315. The function block 315 writes the variable M to a bitstream, and passes control to a function block 320. The function block 320 sets a variable i equal to zero, and passes control to a function block 325. The function block 325 writes a view_id[i] syntax element, and passes control to a function block 330. The function block 330 writes a bitstream_restriction_flag[i] syntax element, and passes control to a decision block 335. The decision block 335 determines whether or not the bitstream restriction_flag[i] syntax element is equal to zero. If so, then control is passed to a decision block 345. Otherwise, control is passed to a function block 340.

The function block 340 writes the bitstream restriction parameters of view i, and passes control to the decision block 345. The decision block 345 determines whether or not the variable i is equal to the variable M. If so, then control is passed to an end block 399. Otherwise, control is passed to a function block 350.

The function block 350 sets the variable i equal to i plus one, and returns control to the function block 325.

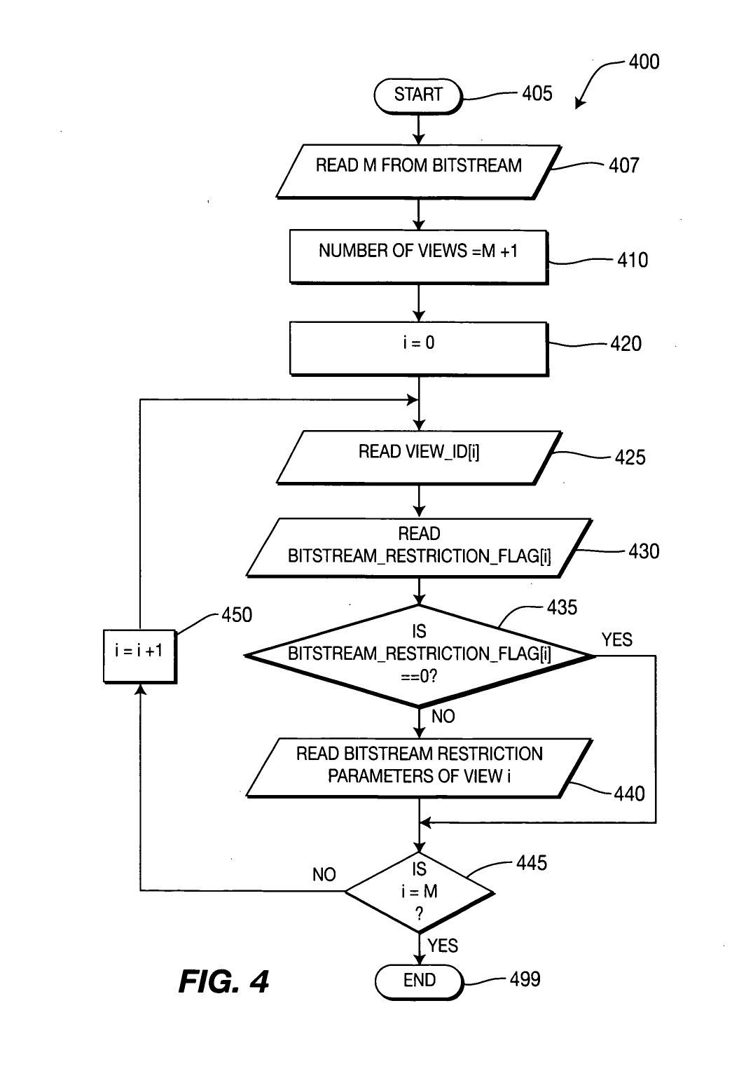

Turning to FIG. 4, an exemplary method for decoding bitstream restriction parameters for each view, using a mvc_vui_parameters_extension( ) syntax element, is indicated generally by the reference numeral 400.

The method 400 includes a start block 405 that passes control to a function block 407. The function block 407 reads a variable M from a bitstream, and passes control to a function block 410. The function block 410 sets the number of views equal to the variable M plus one, and passes control to a function block 420. The function block 420 sets a variable i equal to zero, and passes control to a function block 425. The function block 425 reads a view_id[i] syntax element, and passes control to a function block 430. The function block 430 reads a bitstream_restriction_flag[i] syntax element, and passes control to a decision block 435. The decision block 435 determines whether or not the bitstream restriction_flag[i] syntax element is equal to zero. If so, then control is passed to a decision block 445. Otherwise, control is passed to a function block 440.

The function block 440 reads the bitstream restriction parameters of view i, and passes control to the decision block 445. The decision block 445 determines whether or not the variable i is equal to the variable M. If so, then control is passed to an end block 499. Otherwise, control is passed to a function block 450.

The function block 450 sets the variable i equal to i plus one, and returns control to the function block 425.

### Specifying Bitstream Restriction Parameters for Each Temporal Level of Each View.

Bitstream restriction parameters can be specified for each temporal level of each view. We propose the syntax of mvc_vui_parameters_extension, which is a part of subset_sequence_parameter_set. TABLE 3 illustrates the syntax of mvc_vui_parameters_extension.

TABLE 3

| mvc_vui_parameters_extension( ) { | | C | Descriptor |
|---|---|---|---|
| | num_views_minus1 | 0 | ue(v) |
| | for( i = 0; i <= num_views_minus1; i++ ) { | | |

| | | |
|---|---|---|
| view_id[ i ] | 0 | u(3) |
| num_temporal_layers_in_view_minus1[ i ] | 0 | ue(v) |
| for( j = 0; j <= num_temporal_level_in_view_minus1; j++ ) { | | |

| | | |
|---|---|---|
| temporal_id[ i ][ j ] | | |
| bitstream_restriction_flag[ i ][ j ] | 0 | u(1) |
| if( bitstream_restriction_flag[ i ][ j ] ) { | | |

| | | |
|---|---|---|
| motion_vectors_over_pic_boundaries_flag[ i ][ j ] | 0 | u(1) |
| max_bytes_per_pic_denom[ i ][ j ] | 0 | ue(v) |
| max_bits_per_mb_denom[ i ][ j ] | 0 | ue(v) |
| log2_max_mv_length_horizontal[ i ][ j ] | 0 | ue(v) |
| log2_max_mv_length_vertical[ i ][ j ] | 0 | ue(v) |
| num_reorder_frames[ i ][ j ] | 0 | ue(v) |
| max_dec_frame_buffering[ i ][ j ] | 0 | ue(v) |

}

}

}

}

The semantics of the bitstream restriction syntax elements are as follows:
bitstream_restriction_flag [i][j] specifies the value of bitstream restriction_flag of the temporal level having temporal_id[i][j] equal to temporal_id in the view having view_id[i] equal to view_id. motion_vectors_over_pic_boundaries_flag [i][j] specifies the value of motion_vectors_over_pic_boundaries_flag of the temporal level having temporal_id[i][j] equal to temporal_id in the view having view_id[i] equal to view_id. When the motion_vectors_over_pic_boundaries_flag[i] syntax element is not present, motion_vectors_over_pic_boundaries_flag value of the temporal level having temporal_id[i][j] equal to temporal_id in the view having view_id[i] equal to view_id shall be inferred to be equal to 1.
max_bytes_per_pic_denom [i][j] specifies the max_bytes_per_pic_denom value of the temporal level having temporal_id[i][j] equal to temporal_id in the view having view_id[i] equal to view_id. When the max_bytes_per_pic_denom[i] syntax element is not present, the value of max_bytes_per_pic_denom of the temporal level having temporal_id[i][j] equal to temporal_id in the view having view_id[i] equal to view_id shall be inferred to be equal to 2.
max_bits_per_mb_denom [i][j] specifies the max_bits_per_mb_denom value of the temporal level having temporal_id[i][j] equal to temporal_id in the view having view_id[i] equal to view_id. When the max_bits_per_mb_denom[i] is not present, the value of max_bits_per_mb_denom of the temporal level having temporal_id[i][j] equal to temporal_id in the view having view_id[i] equal to view_id shall be inferred to be equal to 1.
log 2_max_mv_length_horizontal [i][j] and log 2_max_mv_length_vertical [i][j] respectively specify the values of log 2_max_mv_length_horizontal and log 2_max_mv_length_vertical of the temporal level having temporal_id[i][j] equal to temporal_id in the view having view_id[i] equal to view_id. When log 2_max_mv_length_horizontal[i] is not present, the values of log 2_max_mv_length_horizontal and log 2_max_mv_length_vertical of the temporal level having temporal_id[i][j] equal to temporal_id in the view having view_id[i] equal to view_id shall be inferred to be equal to 16.
num_reorder_frames [i][j] specifies the value of num_reorder_frames of the temporal level having temporal_id[i][j] equal to temporal_id in the view having view_id[i] equal to view_id. The value of num_reorder_frames[i] shall be in the range of 0 to max_dec_frame_buffering, inclusive. When the num_reorder_frames[i] syntax element is not present, the value of num_reorder_frames of the temporal level having temporal_id[i][j] equal to temporal_id in the view having view_id[i] equal to view_id shall be inferred to be equal to max_dec_frame_buffering.
max_dec_frame_buffering [i][j] specifies the value of max_dec_frame_buffering of the temporal level having temporal_id[i][j] equal to temporal_id in the view having view_id[i] equal to view_id. The value of max_dec_frame_buffering[i] shall be in the range of num_ref_frames[i] to MaxDpbSize (as specified in sub-clause A.3.1 or A.3.2 in the MPEG-4 AVC Standard), inclusive. When the max_dec_frame_buffering[i] syntax element is not present, the value of max_dec_frame_buffering of the temporal level having temporal_id[i][j] equal to temporal_id in the view having view_id[i] equal to view_id shall be inferred to be equal to MaxDpbSize.

In mvc_vui_parameters_extension( ) two loops are executed. The outer loop loops over all the views associated to the subset_sequence_parameter_set. The view_id for the number of temporal levels of each view is specified in the outer loop. The inner loop loops over all the temporal levels of a view. The bitstream restriction information is specified in the inner loop.

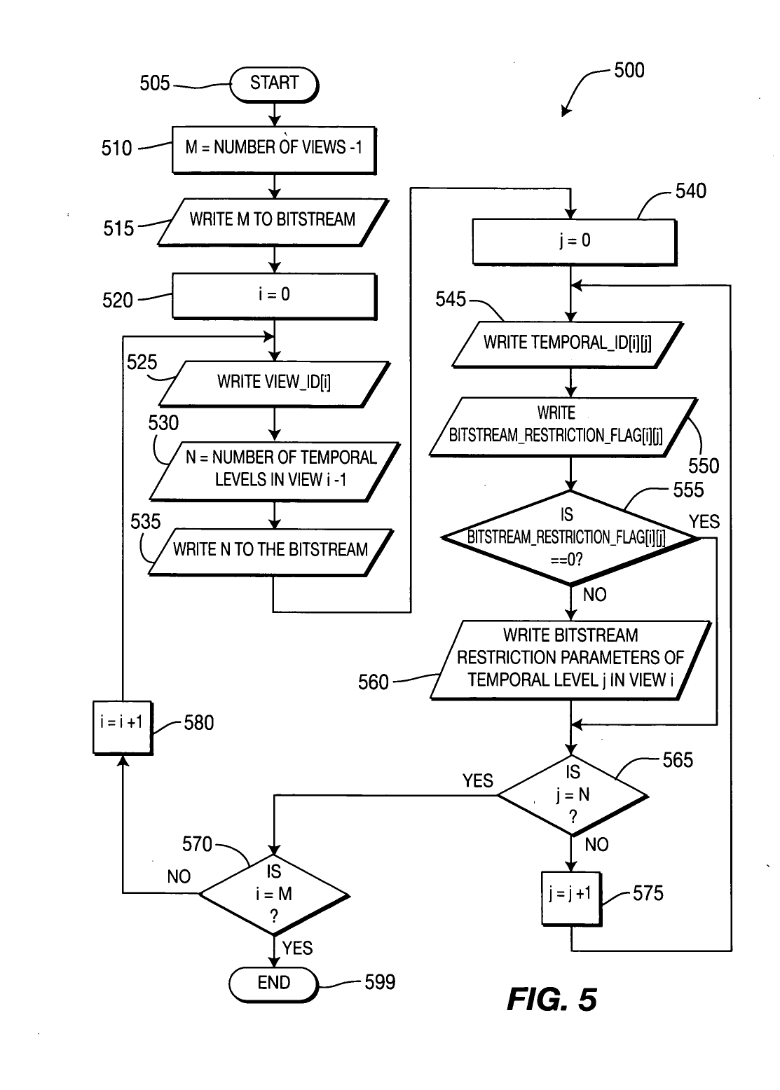

Turning to FIG. 5, an exemplary method for encoding bitstream restriction parameters for each temporal level in each view, using a mvc_vui_parameters_extension( ) syntax element, is indicated generally by the reference numeral 500.

The method 500 includes a start block 505 that passes control to a function block 510. The function block 510 sets a variable M equal to a number of views minus one, and passes control to a function block 515. The function block 515 writes the variable M to a bitstream, and passes control to a function block 520. The function block 520 sets a variable i equal to zero, and passes control to a function block 525. The function block 525 writes a view_id[i] syntax element, and passes control to a function block 530. The function block 530 sets a variable N equal to a number of temporal levels in view i minus 1, and passes control to a function block 535. The function block 535 writes the variable N to the bitstream, and passes control to a function block 540. The function block 540 sets a variable j equal to zero, and passes control to a function block 545. The function block 545 writes a temporal_id[i][j] syntax element, and passes control to a function block 550. The function block 550 writes a bitstream_restriction_flag[i][j] syntax element, and passes control to a decision block 555. The decision block 555 determines whether or not the bitstream restriction_flag[i][j] syntax element is equal to zero. If so, then control is passed to a decision block 565. Otherwise, control is passed to a function block 560.

The function block 560 writes the bitstream restriction parameters of temporal level j in view i, and passes control to the decision block 565. The decision block 565 determines whether or not the variable j is equal to the variable N. If so, then control is passed to a decision block 570. Otherwise, control is passed to a function block 575.

The decision block 570 determines whether or not the variable i is equal to the variable M. If so, then control is passed to an end block 599. Otherwise, control is passed to a function block 580.

The function block 580 sets the variable i equal to i plus one, and returns control to the function block 525.

The function block 575 sets the variable j equal to j plus one, and returns control to the function block 545.

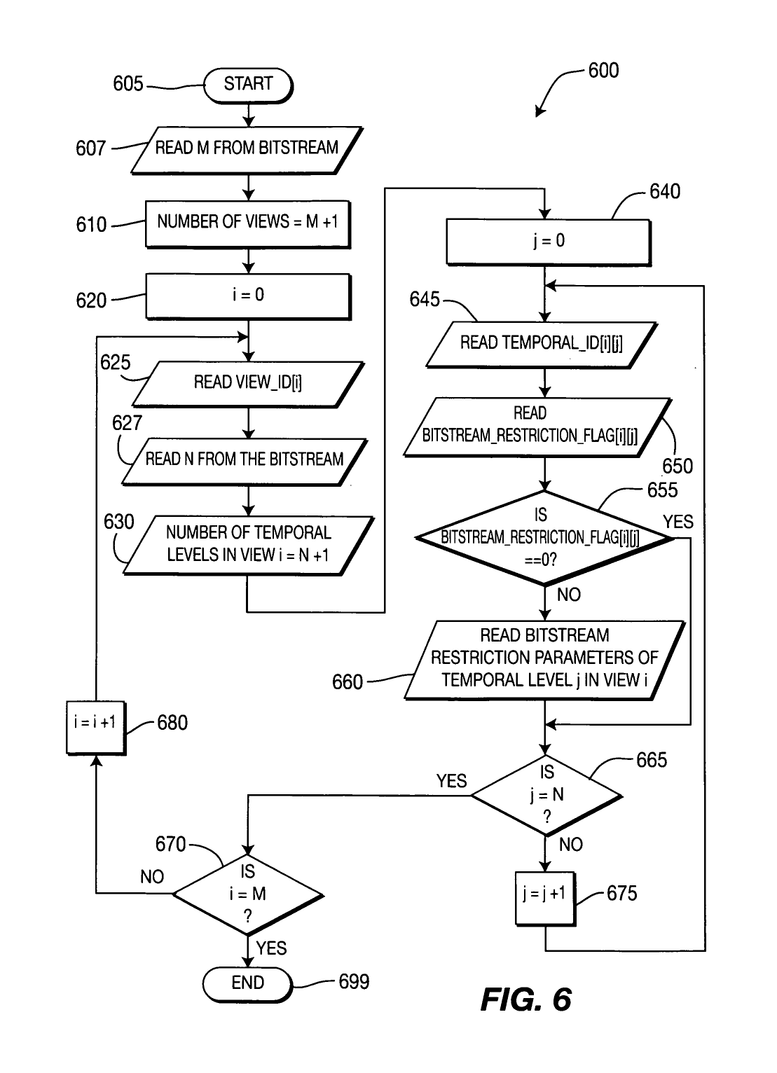

Turning to FIG. 6, an exemplary method for decoding bitstream restriction parameters for each temporal level in each view, using a mvc_vui_parameters_extension( ) syntax element, is indicated generally by the reference numeral 600.

The method 600 includes a start block 605 that passes control to a function block 607. The function block 607 reads a variable M from a bitstream, and passes control to a function block 610. The function block 610 sets a number of views equal to M plus one, and passes control to a function block 620. The function block 620 sets a variable i equal to zero, and passes control to a function block 625. The function block 625 reads a view_id[i] syntax element, and passes control to a function block 627. The function block 627 reads a variable N from the bitstream, and passes control to a function block 630. The function block 630 sets a number of temporal levels in view i equal to N plus 1, and passes control to a function block 640. The function block 640 sets a variable j equal to zero, and passes control to a function block 645. The function block 645 reads a temporal_id[i][j] syntax element, and passes control to a function block 650. The function block 650 reads a bitstream_restriction_flag[i][j] syntax element, and passes control to a decision block 655. The decision block 655 determines whether or not the bitstream restriction_flag[i][j] syntax element is equal to zero. If so, then control is passed to a decision block 665. Otherwise, control is passed to a function block 660.

The function block 660 reads the bitstream restriction parameters of temporal level j in view i, and passes control to the decision block 665. The decision block 665 determines whether or not the variable j is equal to the variable N. If so, then control is passed to a decision block 670. Otherwise, control is passed to a function block 675.

The decision block 670 determines whether or not the variable i is equal to the variable M. If so, then control is passed to an end block 699. Otherwise, control is passed to a function block 680.

The function block 680 sets the variable i equal to i plus one, and returns control to the function block 625.

The function block 675 sets the variable j equal to j plus one, and returns control to the function block 645.

### Specifying Bitstream Restriction Information for Each Operation Point

Bitstream restriction parameters can be specified for each operation point. We propose to convey the bitstream restriction parameters of each operation point in the view scalability information SEI message. The syntax of view scalability information SEI message can be modified as in TABLE 4. The syntax for bitstream restriction information is inserted in a loop that loops over all the operation points.

TABLE 4

| view_scalability_info( payloadSize ) { | | C | Descriptor |
|---|---|---|---|
| | num_operation_points_minus1 | 5 | ue(v) |
| | for( i = 0; i <= num_operation_points_minus1; i++ ) { | | |

| | | |
|---|---|---|
| operation_point_id[ i ] | 5 | ue(v) |
| priority_id[ i ] | 5 | u(5) |
| temporal_id[ i ] | 5 | u(3) |
| num_active_views_minus1[ i ] | 5 | ue(v) |
| for( j = 0; j <= num_active_views_minus1[ i ]; j++ ) | | |

| | | |
|---|---|---|
| view_id[ i ][ j ] | 5 | ue(v) |

| | | |
|---|---|---|
| profile_level_info_present_flag[ i ] | 5 | u(1) |
| bitrate_info_present_flag[ i ] | 5 | u(1) |
| frm_rate_info_present_flag[ i ] | 5 | u(1) |
| op_dependency_info_present_flag[ i ] | 5 | u(1) |
| init_parameter_sets_info_present_flag[ i ] | 5 | u(1) |
| bitstream_restriction_flag[ i ] | | |
| if (profile_level_info_present_flag[ i ]) { | | |

| | | |
|---|---|---|
| op_profile_idc[ i ] | 5 | u(8) |
| op_constraint_set0_flag[ i ] | 5 | u(1) |
| op_constraint_set1_flag[ i ] | 5 | u(1) |
| op_constraint_set2_flag[ i ] | 5 | u(1) |
| op_constraint_set3_flag[ i ] | 5 | u(1) |
| reserved_zero_4bits /* equal to 0 */ | 5 | u(4) |
| op_level_idc[ i ] | 5 | u(8) |

} else

| | |
|---|---|
| profile_level_info_src_op_id_delta[ i ] | ue(v) |

if( bitrate_info_present_flag[ i ]) {

| | | |
|---|---|---|
| avg_bitrate[ i ] | 5 | u(16) |
| max_bitrate[ i ] | 5 | u(16) |
| max_bitrate_calc_window[ i ] | 5 | u(16) |

}
if( frm_rate_info_present_flag[ i [ ) {

| | | |
|---|---|---|
| constant_frm_rate_idc[ i ] | 5 | u(2) |
| avg_frm_rate[ i ] | 5 | u(16) |

} else

| | | |
|---|---|---|
| frm_rate_info_src_op_id_delta[ i ] | 5 | ue(v) |

if(op_dependency_info_present_flag[ i ]) {

| | | |
|---|---|---|
| num_directly_dependent_ops[ i ] | 5 | ue(v) |
| for( j = 0; j < num_directly_dependent_ops[ i ]; j++ ) { | | |
| directly_dependent_op_id_delta_minus1[ i ][ j ] | 5 | ue(v) |

} else

| | | |
|---|---|---|
| op_dependency_info_src_op_id_delta[ i ] | 5 | ue(v) |

if( init_parameter_sets_info_present_flag[ i ] ) {

| | | |
|---|---|---|
| num_init_seq_parameter_set_minus1[ i ] | 5 | ue(v) |
| for( j = 0; j <= num_init_seq_parameter_set_minus1[ i ]; j++ ) | | |

| | | |
|---|---|---|
| init_seq_parameter_set_id_delta[ i ][ j ] | 5 | ue(v) |

| | | |
|---|---|---|
| num_init_pic_parameter_set_minus1 [ i ] | 5 | ue(v) |
| for( j = 0; j <= num_init_pic_parameter_set_minus1 [ i ]; j++ ) | | |

| | | |
|---|---|---|
| init_pic_parameter_set_id_delta[ i ][ j ] | 5 | ue(v) |

} else

| | | |
|---|---|---|
| init_parameter_sets_info_src_op_id_delta[ i ] | 5 | ue(v) |

if ( bitstream_restriction_flag[ i ] ) {

| | | |
|---|---|---|
| motion_vectors_over_pic_boundaries_flag[ i ] | 0 | u(1) |
| max_bytes_per_pic_denom[ i ] | 0 | ue(v) |
| max_bits_per_mb_denom[ i ] | 0 | ue(v) |
| log2_max_mv_length_horizontal[ i ] | 0 | ue(v) |
| log2_max_mv_length_vertical[ i ] | 0 | ue(v) |
| num_reorder_frames[ i ] | 0 | ue(v) |
| max_dec_frame_buffering[ i ] | 0 | ue(v) |

}

}

}

The semantics of the bitstream restriction syntax elements are as follows:
bitstream_restriction_flag [i] specifies the value of bitstream restriction_flag of the operation point having operation_point_id[i] equal to operation_point_id.
motion_vectors_over_pic_boundaries_flag [i] specifies the value of motion_vectors_over_pic_boundaries_flag of the operation point having operation_point_id[i] equal to operation_point_id. When the motion_vectors_over_pic_boundaries_flag[i] syntax element is not present, motion_vectors_over_pic_boundaries_flag value of the operation point having operation_point_id[i] equal to operation_point_id shall be inferred to be equal to 1.
max_bytes_per_pic_denom [i] specifies the max_bytes_per_pic_denom value of the operation point having operation_point_id[i] equal to operation_point_id. When the max_bytes_per_pic_denom[i] syntax element is not present, the value of max_bytes_per_pic_denom of the operation point having operation_point_id[i] equal to operation_point_id shall be inferred to be equal to 2.
max_bits_per_mb_denom [i] specifies the max_bits_per_mb_denom value of the operation point having operation_point_id[i] equal to operation_point_id. When the max_bits_per_mb_denom[i] is not present, the value of max_bits_per_mb_denom of the operation point having operation_point_id[i] equal to operation_point_id shall be inferred to be equal to 1.
log 2_max_mv_length_horizontal [i] and log 2_max_mv_length_vertical [i] respectively specify the value of log 2_max_mv_length_horizontal and the value of log 2_max_mv_length_vertical of the operation point having operation_point_id[i] equal to operation_point_id. When log 2_max_mv_length_horizontal[i] is not present, the values of log 2_max_mv_length_horizontal and log 2_max_mv_length_vertical of the operation point having operation_point_id[i] equal to operation_point_id shall be inferred to be equal to 16.
num_reorder_frames [i] specifies the value of num_reorder_frames of the operation point having operation_point_id[i] equal to operation_point_id. The value of num_reorder_frames[i] shall be in the range of 0 to max_dec_frame_buffering, inclusive. When the num_reorder_frames[i] syntax element is not present, the value of num_reorder_frames of the operation point having operation_point_id[i] equal to operation_point_id shall be inferred to be equal to max_dec_frame_buffering.
max_dec_frame_buffering [i] specifies the value of max_dec_frame_buffering of the operation point having operation_point_id[i] equal to operation_point_id. The value of max_dec_frame_buffering[i] shall be in the range of num_ref_frames[i] to MaxDpbSize (as specified in sub-clause A.3.1 or A.3.2 in the MPEG-4 AVC Standard), inclusive. When the max_dec_frame_buffering[i] syntax element is not present, the value of max_dec_frame_buffering of the operation point having operation_point_id[i] equal to operation_point_id shall be inferred to be equal to MaxDpbSize.

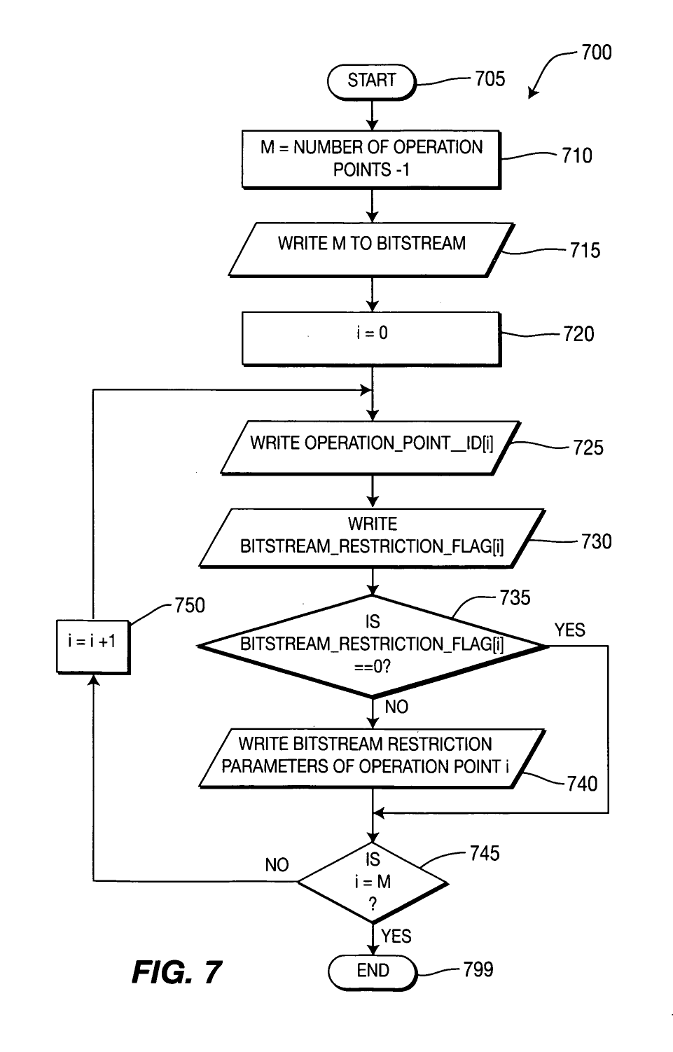

Turning to FIG. 7, an exemplary method for encoding bitstream restriction parameters for each operation point, using a view_scalability_parameters_extension( ) syntax element, is indicated generally by the reference numeral 700.

The method 700 includes a start block 705 that passes control to a function block 710. The function block 710 sets a variable M equal to a number of operation points minus one, and passes control to a function block 715. The function block 715 writes the variable M to a bitstream, and passes control to a function block 720. The function block 720 sets a variable i equal to zero, and passes control to a function block 725. The function block 725 writes an operation_point_id[i] syntax element, and passes control to a function block 730. The function block 730 writes a bitstream_restriction_flag[i] syntax element, and passes control to a decision block 735. The decision block 735 determines whether or not the bitstream restriction_flag[i] syntax element is equal to zero. If so, then control is passed to a decision block 745. Otherwise, control is passed to a function block 740.

The function block 740 writes the bitstream restriction parameters of operation point i, and passes control to the decision block 745. The decision block 745 determines whether or not the variable i is equal to the variable M. If so, then control is passed to an end block 799. Otherwise, control is passed to a function block 750.

The function block 750 sets the variable i equal to i plus one, and returns control to the function block 725.

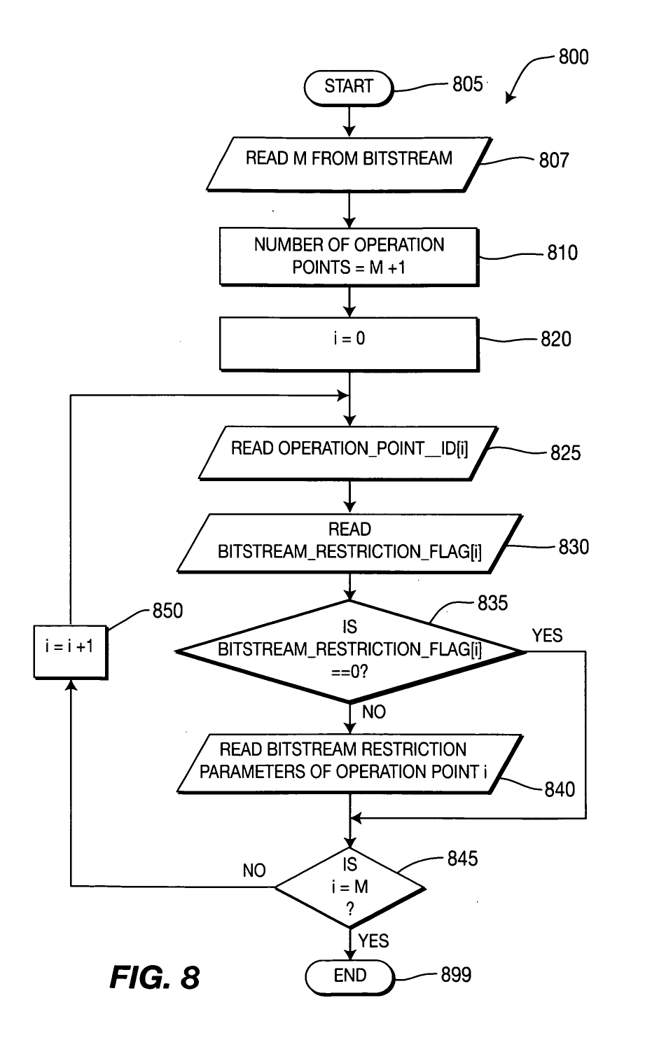

Turning to FIG. 8, an exemplary method for decoding bitstream restriction parameters for each operation point, using a view_scalability_parameters_extension( ) syntax element, is indicated generally by the reference numeral 800.

The method 800 includes a start block 805 that passes control to a function block 807. The function block 807 reads a variable M from a bitstream, and passes control to a function block 810. The function block 810 sets a number of operation points equal to M plus one, and passes control to a function block 820. The function block 820 sets a variable i equal to zero, and passes control to a function block 825. The function block 825 reads an operation_point_id[i] syntax element, and passes control to a function block 830. The function block 830 reads a bitstream_restriction_flag[i] syntax element, and passes control to a decision block 835. The decision block 835 determines whether or not the bitstream restriction_flag[i] syntax element is equal to zero. If so, then control is passed to a decision block 845. Otherwise, control is passed to a function block 840.

The function block 840 reads the bitstream restriction parameters of operation point i, and passes control to the decision block 845. The decision block 845 determines whether or not the variable i is equal to the variable M. If so, then control is passed to an end block 899. Otherwise, control is passed to a function block 850.

The function block 850 sets the variable i equal to i plus one, and returns control to the function block 825.

A description will now be given of some of the many attendant advantages/features of the present invention, some of which have been mentioned above. For example, one advantage/feature is an apparatus that includes an encoder for encoding multi-view video content by specifying video usability information for at least one of individual views, individual temporal levels in a view, and individual operating points.

Another advantage/feature is the apparatus having the encoder as described above, wherein the parameters are specified in at least one high level syntax element.

Moreover, another advantage/feature is the apparatus having the encoder as described above, wherein the at least high level syntax element includes at least one of a mvc_vui_parameters_extension( ) syntax element, a mvc_scalability_info supplemental enhancement information syntax message, at least a portion of a sequence parameters set, a picture parameters set, and supplemental enhancement information.

Further, another advantage/feature is the apparatus having the encoder as described above, wherein at least a portion of the video usability information comprises bitstream restriction parameters.

These and other features and advantages of the present principles may be readily ascertained by one of ordinary skill in the pertinent art based on the teachings herein. It is to be understood that the teachings of the present principles may be implemented in various forms of hardware, software, firmware, special purpose processors, or combinations thereof.

Most preferably, the teachings of the present principles are implemented as a combination of hardware and software. Moreover, the software may be implemented as an application program tangibly embodied on a program storage unit. The application program may be uploaded to, and executed by, a machine comprising any suitable architecture. Preferably, the machine is implemented on a computer platform having hardware such as one or more central processing units (“CPU”), a random access memory (“RAM”), and input/output (“I/O”) interlaces. The computer platform may also include an operating system and microinstruction code. The various processes and functions described herein may be either part of the microinstruction code or part of the application program, or any combination thereof, which may be executed by a CPU. In addition, various other peripheral units may be connected to the computer platform such as an additional data storage unit and a printing unit.

It is to be further understood that, because some of the constituent system components and methods depicted in the accompanying drawings are preferably implemented in software, the actual connections between the system components or the process function blocks may differ depending upon the manner in which the present principles are programmed. Given the teachings herein, one of ordinary skill in the pertinent art will be able to contemplate these and similar implementations or configurations of the present principles.

Although the illustrative embodiments have been described herein with reference to the accompanying drawings, it is to be understood that the present principles is not limited to those precise embodiments, and that various changes and modifications may be effected therein by one of ordinary skill in the pertinent art without departing from the scope or spirit of the present principles. All such changes and modifications are intended to be included within the scope of the present principles as set forth in the appended claims.

1. An apparatus, comprising:
a decoder for decoding multi-view video content by specifying video usability information for at least one selected from: individual views, individual temporal levels in a view, and individual operating points.

2. The apparatus of claim 1, wherein the parameters are specified in at least one high level syntax element.

3. The apparatus of claim 2, wherein the at least one high level syntax element comprises at least one of a mvc_vui_parameters_extension( ) syntax element, a mvc_scalability_info supplemental enhancement information syntax message, at least a portion of a sequence parameters set, a picture parameters set, and supplemental enhancement information.

4. The apparatus of claim 1, wherein at least a portion of the video usability information comprises bitstream restriction parameters.

5. A method, comprising:
decoding multi-view video content by specifying video usability information for at least one selected from: individual views, individual temporal levels in a view, and individual operating points.

6. The method of claim 5, wherein the parameters are specified in at least one high level syntax element.

7. The method of claim 6, wherein the at least one high level syntax element comprises at least one of a mvc_vui_parameters_extension( ) syntax element, a mvc_scalability_info supplemental enhancement information syntax message, at least a portion of a sequence parameters set, a picture parameters set, and supplemental enhancement information.

8. The method of claim 5, wherein at least a portion of the video usability information comprises bitstream restriction parameters.

9. A video signal structure for video encoding, decoding, and transport; comprising:
multi-view video content encoded by specifying video usability information for at least one selected from: individual views, individual temporal levels in a view, and individual operating points.

10. The video signal structure of claim 9, wherein the parameters are specified in at least one high level syntax element.

11. The video signal structure of claim 10, wherein the at least one high level syntax element comprises at least one of a mvc_vui_parameters_extension( ) syntax element, a mvc_scalability_info supplemental enhancement information syntax message, at least a portion of a sequence parameters set, a picture parameters set, and supplemental enhancement information.

12. The video signal structure of claim 9, wherein at least a portion of the video usability information comprises bitstream restriction parameters.
